(19) United States
(12) Patent Application Publication
(10) Pub. No.: US 2026/0352146 A1
(43) Pub. Date: Nov. 5, 2026

(54) PITCH ADJUSTABLE SOLAR TRACKER MOTOR MOUNT

(71) Applicant: Nextpower LLC, Fremont, CA (US)

(72) Inventors: Emma Tam, Petaluma, CA (US); Charles Almy, Berkeley, CA (US)

(21) Appl. No.: 19/661,064

(22) Filed: Apr. 28, 2026

Related U.S. Application Data
(60) Provisional application No. 63/798,404, filed on May 1, 2025.

(51) Int. Cl. H02S 20/32

(52) U.S. Cl. CPC H02S 20/32

(57) ABSTRACT

A pitch adjustable solar tracker motor mount assembly includes a motor configured to receive and rotatably drive a torque tube and a pitch adjustable solar tracker motor mount assembly on which the motor is fixedly attached. The motor mount assembly includes a motor mount base comprising a pitch adjustment slot, a first connecting portion, a second connecting portion, and a third connecting portion. The motor mount base comprising a rounded cross-sectional profile that extends about at least a portion of a perimeter of the motor mount base, and a motor mount saddle comprising a motor support plate and a pitch adjustment flange that extends out from the motor support plate. The pitch adjustment flange is received at the pitch adjustment slot and is movable relative to the pitch adjustment slot to cause a change in pitch orientation of the motor support plate relative to the motor mount base.

### RELATED APPLICATIONS

This application claims the benefit of U.S. Provisional Patent Application No. 63/798,404, filed May 1, 2025, the entire contents of which are incorporated herein by reference.

### TECHNICAL FIELD

This disclosure relates generally to solar power generation systems, and more particularly, to solar tracker motor mounts having variable pitch for a solar tracking system.

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. The solar cells may comprise a solar tracker. A solar tracker is typically comprised of a torque tube that supports the solar panels and is itself supported by piers embedded into the ground. Accordingly, solar panels have great potential to benefit our nation, security, and human users. They can even diversify our energy requirements and reduce the world's dependence on oil and other potentially detrimental sources of energy.

One of the most significant, costly, and time-consuming aspects relating to the manufacture and installation of solar trackers is the requirement that the site be substantially level. While certainly some sites are generally level, most terrain has some undulation and, in some instances, quite a significant pitch to the terrain. In practical terms this required installers of solar trackers to conduct significant amount of earth excavation, moving, and grading. Such earthworks are time consuming, require significant amounts of heavy machinery, and are subject to a significant amount or regulation. Indeed, some projects have been halted owing to the environmental impact of the earthmoving required to produce a relatively level site for the installation of the solar trackers; in others, grading is forbidden.

Further, due to varying terrain, solar tracker supports/piers are precisely installed using GPS and laser to determine accurate placement. If terrain is undulating, it may be difficult to install a torque tube on site at the precisely installed piers without any movement of the piers. The present disclosure seeks to address these shortcomings of prior tracker systems.

### SUMMARY

In general, the present disclosure relates to support structures for solar arrays within a solar tracking system. In particular, embodiments disclosed herein describe a pitch adjustable motor mount that can enable adjusting a pitch orientation of the motor mount, and thus a motor at the motor mount, relative to the motor foundation at which the motor mount is located. The ability to adjust a pitch orientation of the motor mount, and thus motor thereat, can allow the motor mount, and attached motor, to be adjusted (e.g., about an east-west axis) to a degree needed to accommodate solar tracker installation tolerances, for instance, as it relates to torque tube angular orientation relative to the motor mount. Such motor mount pitch adjustability can be particularly useful for solar tracker systems which are installed at rolling, or uneven, ground terrain as the pitch adjustability of the motor at the motor foundation can allow for precise installation of adjacent bearing housing assembly foundations while accommodating necessary installation tolerances, via the pitch adjustability, at the motor truss when installing the torque tube at the motor at the motor truss between the precisely installed, adjacent bearing housing assembly trusses. Embodiments disclosed herein can improve solar tracking system installation efficiency and structural stability by allowing for rotational adjustment of a motor mount (e.g., and motor fixedly attached thereat) about an east-west axis to accommodate an angular orientation needed to connect a torque tube to each side of the motor at the motor mount.

One embodiment includes a pitch adjustable solar tracker motor mount assembly. This motor mount assembly embodiment includes a motor mount base and a motor mount saddle. The motor mound base includes a pitch adjustment slot and a connecting portion. The connecting portion is configured to connect to a ground support. The motor mount saddle includes a motor support plate and a pitch adjustment flange that extends out from the motor support plate. The pitch adjustment flange is received at the pitch adjustment slot, and the pitch adjustment flange is movable relative to the pitch adjustment slot to cause a change in pitch orientation of the motor support plate relative to the motor mount base.

In a further embodiment of this motor mount assembly, the motor mount base includes a rounded cross-sectional profile that extends about at least a portion of a perimeter of the motor mount base.

In a further embodiment of this motor mount assembly, the motor mount assembly further includes a U-bolt that movably connects the motor mount saddle to the motor mount base. The U-bolt can extend around at least the portion of the perimeter of the motor mount base having the rounded cross-sectional profile. As the pitch adjustment flange moves relative to the pitch adjustment slot to cause the change in pitch orientation of the motor support plate relative to the motor mount base, the U-bolt can move about at least the portion of the perimeter of the motor mount base having the rounded cross-sectional profile. The motor support plate can define a planar motor support surface, and a threaded end of the U-bolt can extend through the planar motor support surface for mounting a motor at the planar motor support surface using at least the threaded end of the U-bolt. The connecting portion can extend out from the rounded cross-sectional profile of the motor mount base.

In a further embodiment of this motor mount assembly, the pitch adjustment flange includes a flange cross-sectional area that extends in a north-south plane. Where the pitch adjustment slot receives the pitch adjustment flange, the pitch adjustment slot includes a slot cross-sectional area that extends in the north-south plane, with the slot cross-sectional area being greater than the flange cross-sectional area in the north-south plane. The flange cross-sectional area can further extend in an east-west plane, and, where the pitch adjustment slot receives the pitch adjustment flange, the pitch adjustment slot includes the slot cross-sectional area that further extends in the east-west plane, and this slot cross-sectional area extending in the east-west plane is greater than the flange cross-sectional area extending in the east-west plane. The motor mount assembly can further include a saddle leg extending from a first saddle leg end at the motor support plate to a second saddle leg end opposite the first saddle leg end, and the second saddle leg end can include the pitch adjustment flange, a first rounded surface that extends to a north side of the pitch adjustment flange, and a second rounded surface that extends to a south side of the pitch adjustment flange. The saddle leg includes a first saddle leg, the pitch adjustment flange comprises a first pitch adjustment flange, and the pitch adjustment slot comprises a first pitch adjustment slot. The motor mount assembly can further include a second pitch adjustment slot at the motor mount base, and a second saddle leg extends from a second saddle leg first end at the motor support plate to a second saddle leg second end opposite the second saddle leg first end. The second saddle leg second end includes a second pitch adjustment flange, a third rounded surface that extends to a north side of the second pitch adjustment flange, and a fourth rounded surface that extends to a south side of the second pitch adjustment flange. The second pitch adjustment flange is received at the second pitch adjustment slot, and the second pitch adjustment flange is movable: (i) with the first pitch adjustment flange and (ii) relative to the second pitch adjustment slot to cause the change in pitch orientation of the motor support plate relative to the motor mount base.

Another embodiment includes a pitch adjustable motor truss. This motor truss embodiment includes a motor, a pitch adjustable solar tracker motor mount, and first, second, and third truss legs. The motor is configured to receive and rotatably drive a torque tube. The motor is fixedly attached to pitch adjustable solar tracker motor mount assembly. The pitch adjustable solar tracker motor mount assembly includes a motor mount base and a motor mount saddle. The motor mount base includes a pitch adjustment slot, a first connecting portion, a second connecting portion, and a third connecting portion. The motor mount base includes a rounded cross-sectional profile that extends about at least a portion of a perimeter of the motor mount base. The motor mount saddle includes a motor support plate and a pitch adjustment flange that extends out from the motor support plate. The pitch adjustment flange is received at the pitch adjustment slot, and the pitch adjustment flange is movable relative to the pitch adjustment slot to cause a change in pitch orientation of the motor support plate relative to the motor mount base. The first truss leg is connected to the first connecting portion, the second truss leg is connected to the second connecting portion, and the third truss leg is connected to the third connecting portion.

In a further embodiment of this motor truss, the motor truss further comprises a U-bolt that movably connects the motor mount saddle to the motor mount base. As the pitch adjustment flange moves relative to the pitch adjustment slot to cause the change in pitch orientation of the motor support plate relative to the motor mount base, the U-bolt moves about at least the rounded cross-sectional profile of the motor mount base. A threaded end of the U-bolt extends through the motor support plate, and the motor is fixedly attached to the motor support plate at least via the threaded end of the U-bolt. Each of the first connecting portion, the second connecting potion, and the third connecting portion extend out from the rounded cross-sectional profile of the motor mount base. The motor mount base can further include a first damper mount flange and a second damper mount flange, with each of the first damper mount flange and the second damper mount flange extending out from the rounded cross-sectional profile of the motor mount base between the first connecting portion and the second connecting portion.

Another embodiment includes a method for installing a motor at a pitch adjustable solar tracker motor mount assembly. This method embodiment includes the step of movably attaching a motor mount saddle at a motor mount base of the pitch adjustable solar tracker motor mount assembly. The motor mount saddle includes a motor support plate and a pitch adjustment flange that extends out from the motor support plate. The motor mount base includes a pitch adjustment slot, and the pitch adjustment flange is movably received at the pitch adjustment slot to movably attach the motor mount saddle at the motor mount base. This method embodiment further includes the steps of: attaching a motor to the motor support plate; changing a pitch orientation of the motor by moving the motor support plate in a north-south plane relative to the motor mount base at least by moving the pitch adjustment flange relative to the pitch adjustment slot in the north-south plane; and after changing the pitch orientation of the motor, attaching a torque tube at the motor.

In a further embodiment of this method, the motor mount base includes a rounded cross-sectional profile that extends about at least a portion of a perimeter of the motor mount base. The motor mount saddle is movably attached to the motor mount base by a U-bolt that bounds at least a portion of the rounded cross-sectional profile of the motor mount base. Changing the pitch orientation of the motor by moving the motor support plate comprises moving the U-bolt in the north-south plane about the rounded cross-sectional profile of the motor mount base.

In a further embodiment of this method, the torque tube is attached to the motor after each of: (i) the torque tube has been attached to a bearing housing assembly truss that is spaced apart from the pitch adjustable solar tracker motor mount assembly, and (ii) the pitch orientation of the motor is changed.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3A is a perspective view of a pitch adjustable motor truss;

FIG. 3B is an elevational view in an east-west plane shown an east or west side of the pitch adjustable motor truss;

FIG. 3C is an elevational view in a north-south plane showing at a north or south side of the pitch adjustable motor truss;

FIG. 4A is a top perspective view of this pitch adjustable solar tracker motor mount assembly;

FIG. 4B is a perspective view of this pitch adjustable solar tracker motor mount assembly;

FIG. 4C is a cross-sectional view taken along line C-C at FIG. 4B;

FIG. 4D is a cross-sectional view taken along line D-D at FIG. 4B; and

FIG. 5 illustrates a flow diagram of an embodiment of a method for installing a motor at a pitch adjustable solar tracker motor mount assembly.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker motor mounts. Certain embodiments disclosed herein relate to solar tracker motor mounts configured to provide pitch adjustability that can enable installation orientation tolerance and flexibility at motor foundation(s). This can be particularly useful for solar tracker systems which are installed at rolling or uneven ground terrain as the pitch adjustability of the motor at the motor foundation can allow for precise installation of adjacent bearing housing assembly foundations while accommodating necessary installation tolerances, via the pitch adjustability, at the motor truss when installing the torque tube at the motor at the motor truss between the precisely installed, adjacent bearing housing assembly trusses. Embodiments disclosed herein can improve solar tracking system installation efficiency and structural stability by allowing for rotational adjustment of a motor mount (e.g., and motor fixedly attached thereat) about an east-west axis to accommodate an angular orientation needed to connect a torque tube to each side of the motor at the motor mount.

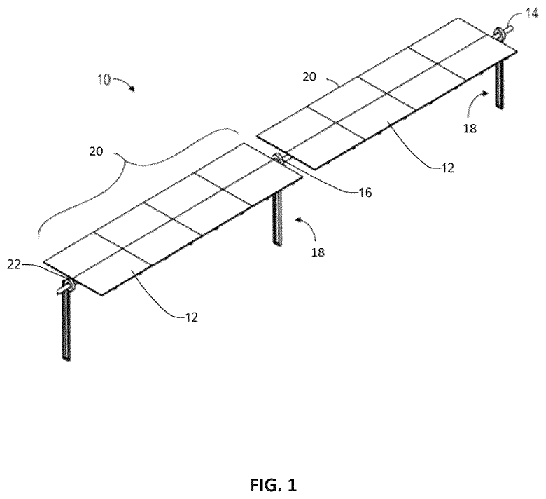

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedments in the ground, such as one for each leg of an A-frame support where the embedments are spaced apart in the east-west direction. Alternatively, piles 18 may be a conventional solar I-beam known in the art as an H-pile. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or, generally near the center of the solar tracker 10, a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

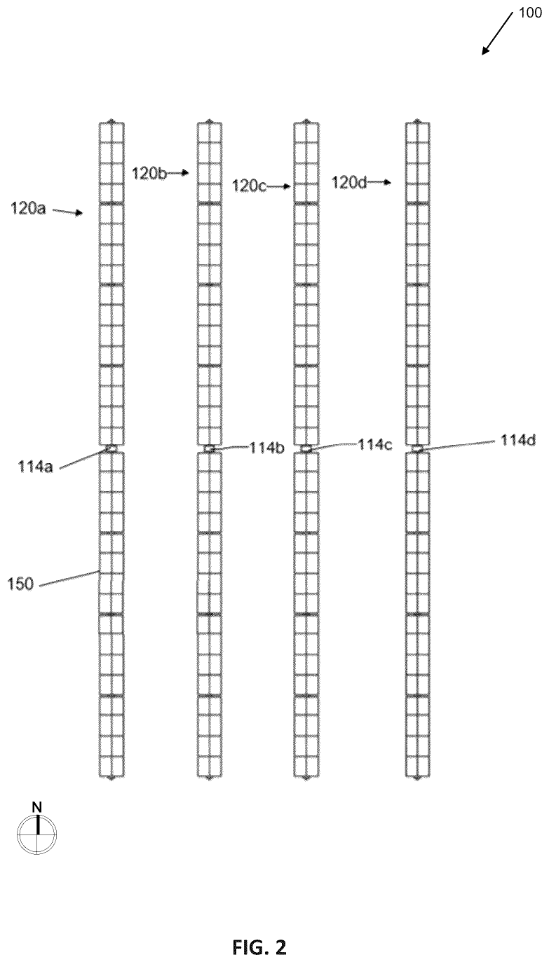

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

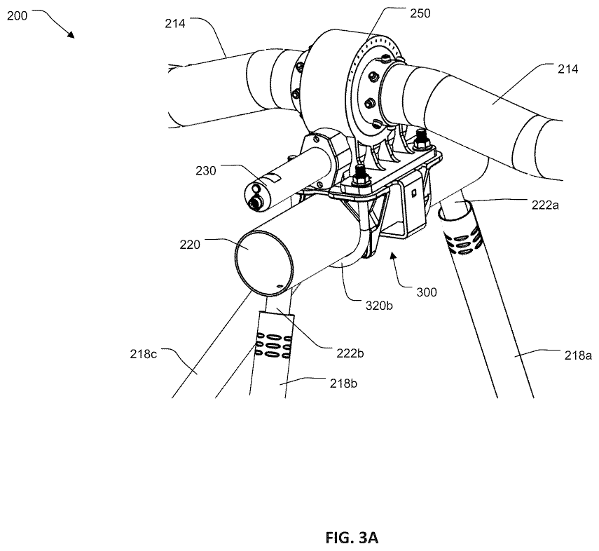

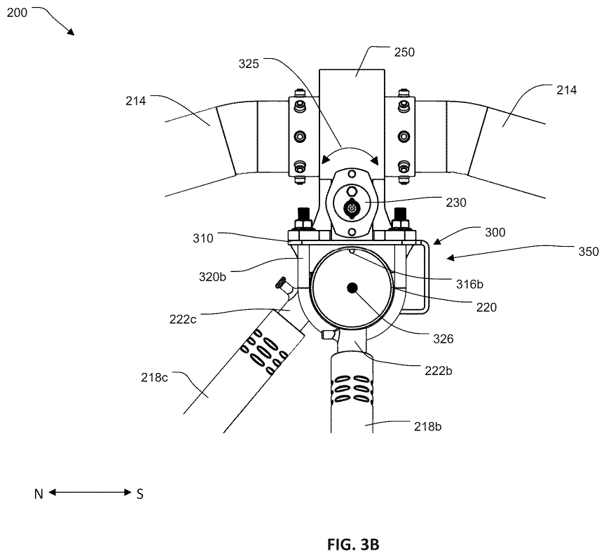

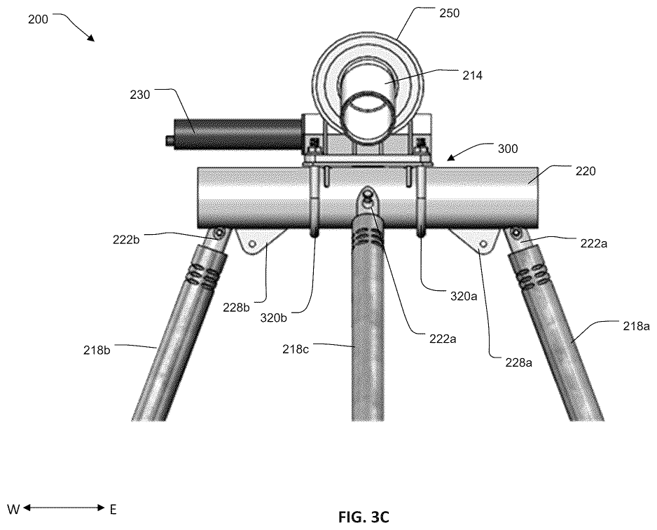

FIGS. 3A to 3C illustrate an embodiment of a pitch adjustable motor truss assembly 200. FIG. 3A is a perspective view of the pitch adjustable motor truss assembly 200, FIG. 3B is an elevational view in an east-west plane showing an east or west side of the pitch adjustable motor truss assembly 200, and FIG. 3C is an elevational view in a north-south plane showing at a north or south side of the pitch adjustable motor truss assembly 200. The pitch adjustable motor truss assembly 200, generally referred to herein as the motor truss assembly 200, may include a motor 250 configured to receive and rotatably drive a torque tube 214, and a pitch adjustable solar tracker motor mount assembly 300, generally referred to herein as motor mount assembly 300, on which the motor 250 may be fixedly attached. It will be appreciated that the torque tube 214 extends from the motor 250 in a north-south direction, as shown in FIG. 3B. In some examples, the motor 250 may be a slew motor and may include a slew member 230. In other examples, the motor 250 can be another type of motor suitable for imparting rotational torque to the torque tube 214.

In some examples, as shown in FIGS. 3A to 3C, the motor mount assembly 300 may include a motor mount base 220 that may include a first connecting portion 222a, a second connecting portion 222b, and a third connecting portion 222c, each projecting away from the motor mount base 220. Each of the first connecting portion 222a, the second connecting portion 222b, and the third connecting portion 222c may be configured to be coupled to a ground support, such as, a first truss leg 218a, a second truss leg 218b, and a third truss leg 218c, respectively. An open end of each of the first truss leg 218a, the second truss leg 218b, and the third truss leg 218c may be sleeved over the first connecting portion 222a, the second connecting portion 222b, and the third connecting portion 222c, respectively. Then crimps are formed over the overlapping portion of each of the first truss leg 218a, the second truss leg 218b, and the third truss leg 218c to lock each truss leg 218a, 218b, 218c in place. The motor mount base 220 may further include a first damper mount flange 228a and a second damper mount flange 228b, as shown in FIG. 3C. The first connecting portion 222a, the second connecting portion 222b, the first connecting portion 222c, the first damper mount flange 228a, and the second damper mount flange 228b may help absorb wind load.

The motor mount base 220 may include a rounded cross-sectional profile that may extend about at least a portion of a perimeter of the motor mount base 220, and each of the first connecting portion 222a, the second connecting portion 222b, and the third connecting portion 222c may extend out from the rounded cross-sectional profile of the motor mount base 220. In some examples, when included, each of the first damper mount flange 228a and the second damper mount flange 228b may extend out from the rounded cross-sectional profile of the motor mount base 220 between the first connecting portion 222a and the second connecting portion 222b. While it is shown that the motor mount base 220 may include a circular cross-sectional profile, it may be contemplated that the motor mount base 220 may include an oval cross-sectional profile, and/or a cross-sectional profile such that a bottom portion of the motor mount base 220 includes a rounded cross-sectional profile and an upper portion may include a partial square, partial hexagonal, partial rectangular, or any other suitable partial cross-sectional profile as desired.

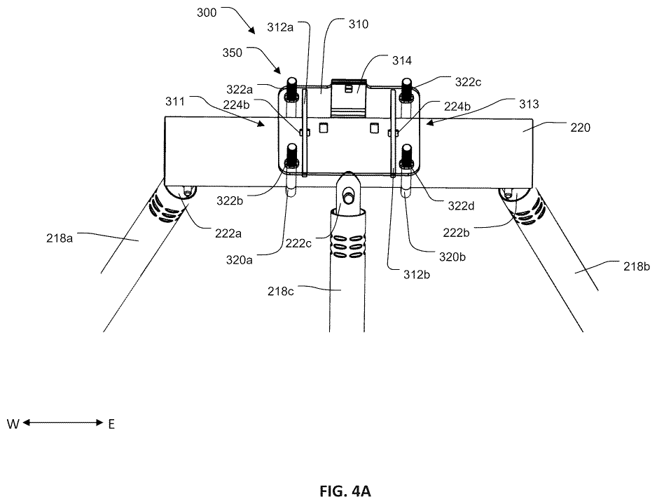

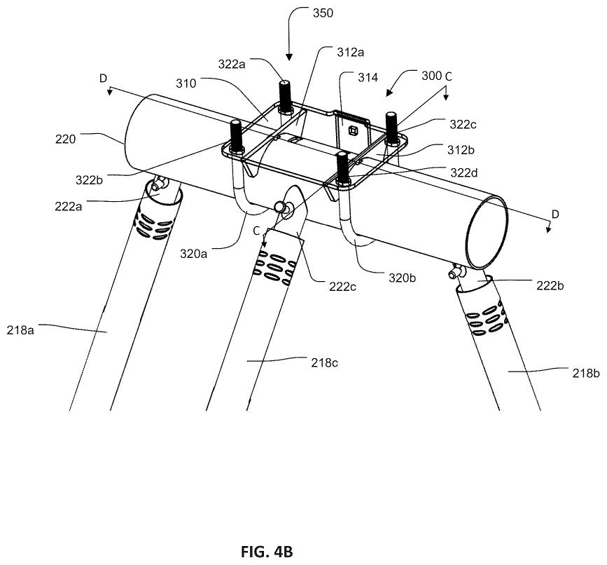

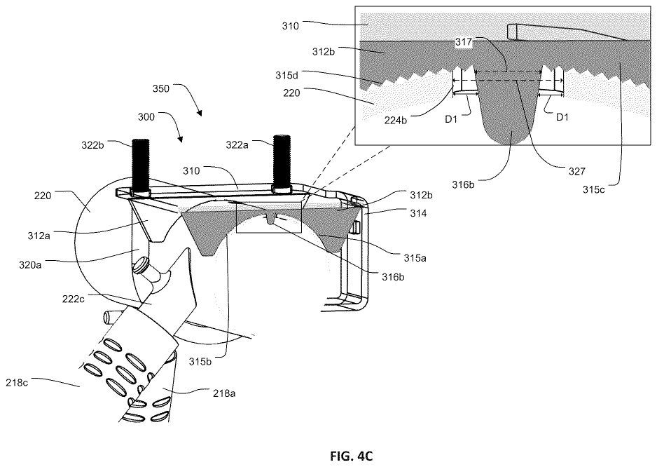

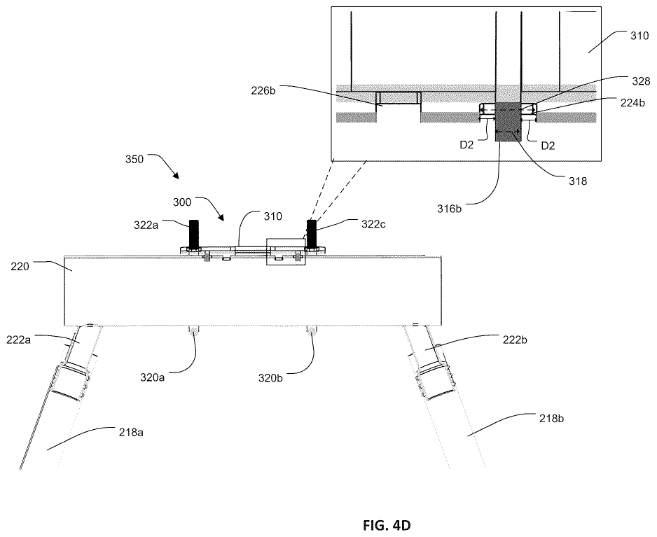

The motor mount assembly 300 may further include a motor mount saddle 350 comprising a motor support plate 310 and at least one pitch adjustment flange 316b (FIG. 3B), extending out from the motor support plate 310. The motor mount assembly 300, the motor mount saddle 350, and components thereof will be discussed in further detail with reference to FIGS. 4A to 4D. In some examples, a first U-bolt 320a and a second U-bolt 320b may be configured to movably connect the motor mount saddle 350 to the motor mount base 320. The first U-bolt 320a and the second U-bolt 320b may include a size and shape such that rotational engagement with the rounded cross-sectional profile of the motor mount base 220 is permitted. The rotational engagement of the first U-bolt 320a and the second U-bolt 320b with the motor mount base 220 allows rotation of the motor mount saddle 350 relative to the motor mount base 220 as the first U-bolt 320a and the second U-bolt 320b are secured to the motor mount saddle 350. The pitch adjustment flange 316b engages with a pitch adjustment slot, as will be described further herein with reference to FIGS. 4A to 4D, to permit pitch adjustability of the motor mount saddle 350, and thereby the motor 250, in a north-south direction, as indicated by arrow 325 in FIG. 3B, about an east-west axis 326 of the motor mount base 220. Pitch adjustability in the north-south direction allows for the torque tube 214 to be coupled to the motor 250, as the adjustability follows the direction of the torque tube 214. In this manner, the motor 250 is permitted to “move” to meet the torque tube 214 during assembly of the solar tracker row. Pitch adjustability will be discussed further herein, with reference to FIGS. 4A to 4D.

FIGS. 4A to 4D illustrate an embodiment of the pitch adjustable solar tracker motor mount assembly 300 as shown for the pitch adjustable motor truss assembly 200. FIG. 4A is a top perspective view of the pitch adjustable solar tracker motor mount assembly 300, and FIG. 4B is a perspective view of the pitch adjustable solar tracker motor mount assembly 300. FIG. 4C is a cross-sectional view of the pitch adjustable solar tracker motor mount assembly 300 taken along line C-C at FIG. 4B, and FIG. 4D is a cross-sectional view of the pitch adjustable solar tracker motor mount assembly 300 taken along line D-D at FIG. 4B. The pitch adjustable solar tracker motor mount assembly 300, generally referred to herein as motor mount assembly 300, may include the motor mount base 220 that may include a rounded cross-sectional profile that may extend about at least a portion of a perimeter of the motor mount base 220, and the first connecting portion 222a, the second connecting portion 222b, and the third connecting portion 222c may extend out from the rounded cross-sectional profile of the motor mount base 220, as discussed elsewhere herein.

As previously discussed, the motor mount assembly 300 may include the motor mount saddle 350 comprising the motor support plate 310 that may define a planar motor support surface. The motor support plate 310 is shown as transparent in FIGS. 4A to 4D. The motor mount assembly 300 may also include a wire retention member 314 that may be configured to interface with the motor mount base 220 to hold wires for the motor 250 below the motor itself 250. The motor support plate 310 may be configured to engage with the motor 250 to secure the motor 250 and the torque tube 214 to the truss legs 218a, 218b, 218c. The motor support plate 310 may include a first saddle leg end 311 and a second saddle leg end 313, opposite the first saddle leg end 311, as shown in FIG. 4A. A first saddle leg 312a may extend from the first saddle leg end 311, and a second saddle leg 312b may extend from the second saddle leg end 313. In some examples, the first saddle leg 312a may include a first pitch adjustment flange 316a positioned between a first rounded surface that extends to a north side of the first pitch adjustment flange 316a and a second rounded surface that extends to a south side of the first pitch adjustment flange 316a. The second saddle leg 312b may include a second pitch adjustment flange 316b positioned between a third rounded surface 315c that extends to a north side of the second pitch adjustment flange 316b and a fourth rounded surface 315d that extends to a south side of the second pitch adjustment flange 316b, as shown in FIG. 4C. While the second saddle leg 312b is described with reference to FIG. 4C, it will be appreciated that the description thereof further applies to the first saddle leg 312a. Each of the first pitch adjustment flange 316a and the second pitch adjustment flange 316b may include a flange cross-sectional area that extends in a north-south plane, as indicated by dashed line 317 in FIG. 4C, and a flange cross-sectional area that extends in an east-west plane, as indicated by dashed line 318 in FIG. 4D.

The motor mount assembly 300 may be coupled to the motor mount base 220 via the first U-bolt 320a and the second U-bolt 320b. As shown in FIGS. 4A and 4B, a first threaded end 322a and a second threaded end 322b of the first U-bolt 320a, and a third threaded end 322c and a fourth threaded end 322d of the second U-bolt 320b may extend through the planar motor support surface of the motor support plate 310 for mounting the motor 250 at the planar motor support surface of the motor support plate 310 using at least the threaded ends 322a, 322b, 322c, 322d of the respective U-bolts 320a, 320b. The first U-bolt 320a and the second U-bolt 320b may each movably connect the motor mount saddle 350 to the motor mount base 220, as each of the first U-bolt 320a and the second U-bolt 320b extends around at least the portion of the perimeter of the motor mount base 220 having the rounded cross-sectional profile.

In some examples, the motor mount base 220 mount base may include a first pitch adjustment slot 224a and a second pitch adjustment slot 224b within a portion of the motor mount base 220. The first pitch adjustment slot 224a and the second pitch adjustment slot 224b may each include a slot cross-sectional area that extends in the north-south plane, as indicated by dashed line 327 in FIG. 4C. The first pitch adjustment slot 224a and the second pitch adjustment slot 224b may also each include a slot cross-sectional area that extends in the east-west plane, as indicated by dashed line 328 in FIG. 4D. The slot cross-sectional area in the north-south plane 327 and the east-west plane 328 may be greater than the flange cross-sectional area in the north-south plane 317 and the east-west plane 318, respectively. For example, the slot cross sectional area in the north-south plane 327 may be large enough to allow for a pitch in a range of about 0.5-degrees to about 10-degrees. In some examples, the range of pitch may be about 1-degree to about 5-degrees. In some examples, the range of pitch may be about +/−1.6-degrees. The slot cross-sectional area may be sized to allow for a pitch giving enough flexibility of the motor mount assembly 300 when connecting the torque tube 214 to the motor 250. In some examples, the first pitch adjustment slot 224a and the second pitch adjustment slot 224b may act as a hard stop as the first pitch adjustment flange 316a and the second pitch adjustment flange 316b engage with the first pitch adjustment slot 224a and the second pitch adjustment slot 224b, thereby preventing the motor mount assembly 300 and the motor 250 from rotating too far. Further, the size of the slot cross-sectional area may not be too large, as too much pitch may change the orientation of the motor mount assembly 300 too much, thereby causing the motor 250 to fall off the motor mount assembly 300 during installation.

The first pitch adjustment slot 224a and the second pitch adjustment slot 224b may each be configured to receive the first pitch adjustment flange 316a and the second pitch adjustment flange 316b, respectively. The first pitch adjustment flange 316a may be movable relative to the first pitch adjustment slot 324a, and the second pitch adjustment flange 316b may be movable: (i) with the first pitch adjustment flange 316a and (ii) relative to the second pitch adjustment slot 324b. Movement of the first pitch adjustment flange 316a relative to the first pitch adjustment slot 324a and the second pitch adjustment flange 316b relative to the second pitch adjustment slot 324b may cause the change in pitch orientation of the motor support plate 310 relative to the motor mount base 220. In some examples, as the first pitch adjustment flange 316a moves relative to the first pitch adjustment slot 324a and the second pitch adjustment flange 316b moves relative to the second pitch adjustment slot 324b, the first U-bolt 320a and the second U-bolt 320b may move about at least the portion of the perimeter of the motor mount base 220 having the rounded cross-sectional profile.

The motor mount assembly 300 may be coupled to the first truss leg 218a, the second truss leg 218b, and the third truss leg 218c via the first connecting member 222a, the second connecting member 222b, and the third connecting member 222c, respectively. As the motor mount saddle 350 is coupled to the motor mount base 220, the first pitch adjustment flange 316a is aligned with the first pitch adjustment slot 324a and the second pitch adjustment flange 316b is aligned with the second pitch adjustment slot 324b. To couple the motor mount saddle 350 to the motor mount base 220, the first pitch adjustment flange 316a and the second pitch adjustment flange 316b are placed within the first pitch adjustment slot 324a and the second pitch adjustment slot 324b, respectively. The first rounded surface and the second rounded surface of the first saddle leg 312a abut the rounded surface of the motor mount base 220 and the third rounded surface 315c and the fourth rounded surface 315d of the second saddle leg 312b abut the rounded surface of the motor mount base 220, as the rounded surfaces of the first saddle leg 312a and the second saddle leg 312b complement the rounded surface of the motor mount base 220. The motor mount assembly 300 is then secured to the motor mount base 220 via the U-bolts 220a, 220b. While it is described that the motor mount assembly 300 includes saddle legs 312a, 312b including rounded surfaces, it may be contemplated that the saddle legs 312a, 312b may include angular surfaces, such as square, hexagonal, or the like, just so long as the surfaces of the saddle legs 312a, 312b complement the surface of the motor mount base 220.

During installation, the motor 250 is then placed on the motor mount assembly 300 by aligning one or more openings of the motor 250 with the threaded ends 322a, 322b, 322c, 322d of the respective U-bolts 320a, 320b, and lowering the motor 250 onto the motor support assembly 300. This alignment permits the motor 250 to contact the motor support plate 310 and maintain its position relative to the motor support plate 310. A plurality of nuts may then be loosely threaded onto the threaded ends 322a, 322b, 322c, 322d of the respective U-bolts 320a, 320b to hold the motor 250 in position. In some examples, coupling of the torque tube 214 to the motor 250 may put strain on the motor 250, and thereby the truss legs 218a, 218b, 218c, which may cause a shift in the placement of the truss legs 218a, 218b, 218c. To combat this, the first pitch adjustment flange 316a and the second pitch adjustment flange 316b, which have a flange cross-sectional area less than a slot cross-sectional area of the first pitch adjustment slot 324a and the second pitch adjustment slot 324b, respectively, may be permitted to move within the first pitch adjustment slot 324a and the second pitch adjustment slot 324b via a pitch adjustment in a north-south plane. This pitch adjustment permits a change in orientation of the motor mount assembly 300, and thereby the motor 250, to allow the torque tube 214 to be coupled to the motor 250 without undue displacement or bending of the truss legs 218a, 218b, 218c. This pitch adjustment in a north-south plane occurs as the U-bolts 220a, 220b rotate in an east-west plane, thereby moving the motor mount assembly 300 in an east-west plane. Once the torque tube 214 is coupled to the motor 250, the nuts may be securely fastened to the threaded ends 322a, 322b, 322c, 322d of the respective U-bolts 320a, 320b.

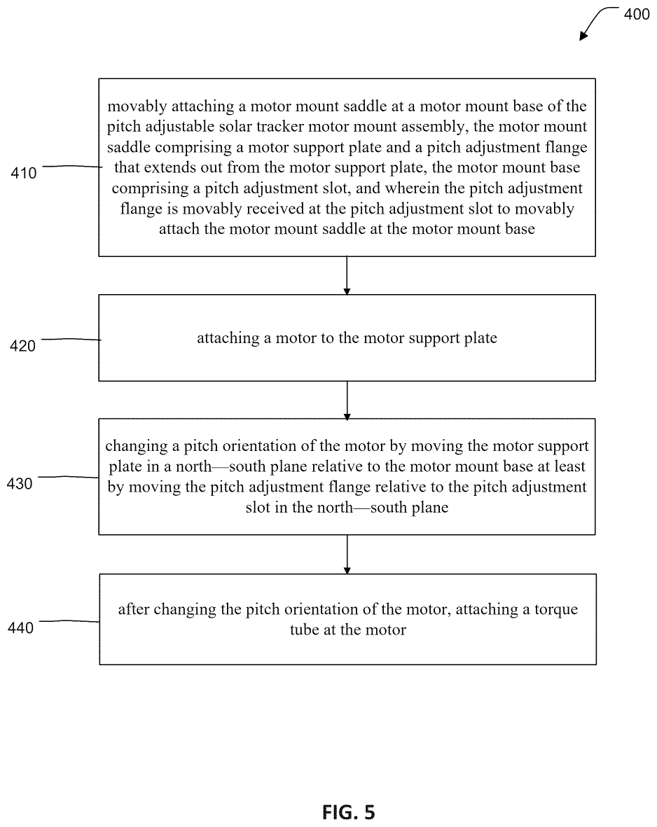

FIG. 5 illustrates a flow diagram of an embodiment of a method 400 for installing a motor at a pitch adjustable solar tracker motor mount assembly, such as, the pitch adjustable solar tracker motor mount assembly 300, described elsewhere herein. The method 400 may include movably attaching a motor mount saddle at a motor mount base of the pitch adjustable solar tracker motor mount assembly 300. The motor mount saddle may include a motor support plate and a pitch adjustment flange that extends out from the motor support plate. The motor mount base may include a pitch adjustment slot, where the pitch adjustment flange may be movably received at the pitch adjustment slot to movably attach the motor mount saddle at the motor mount base, as referenced by block 410. In some examples, the motor mount base may include a rounded cross-sectional profile that may extend about at least a portion of the perimeter of the motor mount base. The method 400 may further include attaching a motor to the motor support plate, as referenced by block 420, and changing a pitch orientation of the motor by moving the motor support plate in a north-south plane relative to the motor mount base at least by moving the pitch adjustment flange relative to the pitch adjustment slot in the north-south plane, as referenced by block 430. After changing the pitch orientation of the motor, the method 400 may include attaching a torque tube at the motor, as referenced by block 440.

In some examples, as described elsewhere herein, the motor mount saddle may be movably attached to the motor mount base by a U-bolt that bounds at least a portion of the rounded cross-sectional profile of the motor mount base. Changing the pitch orientation of the motor by moving the motor support plate may include moving the U-bolt in the north-south plane about the rounded cross-sectional profile of the motor mount base.

As discussed elsewhere herein, the torque tube may be attached to the motor after each of: (i) the torque tube has been attached to a bearing housing assembly truss that is spaced apart from the pitch adjustable solar tracker motor mount assembly, and (ii) the pitch orientation of the motor is changed.

Various non-limiting exemplary embodiments have been described. It will be appreciated that suitable alternatives are possible without departing from the scope of the examples described herein.

What is claimed is:

1. A pitch adjustable solar tracker motor mount assembly comprising:
a motor mount base comprising a pitch adjustment slot and a connecting portion, the connecting portion configured to connect to a ground support; and
a motor mount saddle comprising a motor support plate and a pitch adjustment flange that extends out from the motor support plate,
wherein the pitch adjustment flange is received at the pitch adjustment slot, and wherein the pitch adjustment flange is movable relative to the pitch adjustment slot to cause a change in pitch orientation of the motor support plate relative to the motor mount base.

2. The motor mount assembly of claim 1, wherein the motor mount base comprises a rounded cross-sectional profile that extends about at least a portion of a perimeter of the motor mount base.

3. The motor mount assembly of claim 1, further comprising:
a U-bolt that movably connects the motor mount saddle to the motor mount base.

4. The motor mount assembly of claim 3, wherein the U-bolt extends around at least the portion of the perimeter of the motor mount base having the rounded cross-sectional profile.

5. The motor mount assembly of claim 4, wherein, as the pitch adjustment flange moves relative to the pitch adjustment slot to cause the change in pitch orientation of the motor support plate relative to the motor mount base, the U-bolt moves about at least the portion of the perimeter of the motor mount base having the rounded cross-sectional profile.

6. The motor mount assembly of claim 5, wherein the motor support plate defines a planar motor support surface, and wherein a threaded end of the U-bolt extends through the planar motor support surface for mounting a motor at the planar motor support surface using at least the threaded end of the U-bolt.

7. The motor mount assembly of claim 3, wherein the connecting portion extends out from the rounded cross-sectional profile of the motor mount base.

8. The motor mount assembly of claim 1,
wherein the pitch adjustment flange comprises a flange cross-sectional area that extends in a north-south plane,
wherein where the pitch adjustment slot receives the pitch adjustment flange the pitch adjustment slot comprises a slot cross-sectional area that extends in the north-south plane, and
wherein the slot cross-sectional area is greater than the flange cross-sectional area in the north-south plane.

9. The motor mount assembly of claim 8,
wherein the flange cross-sectional area further extends in an east-west plane,
wherein where the pitch adjustment slot receives the pitch adjustment flange the pitch adjustment slot comprises the slot cross-sectional area that further extends in the east-west plane, and wherein the slot cross-sectional area extending in the east-west plane is greater than the flange cross-sectional area extending in the east-west plane.

10. The motor mount assembly of claim 8, further comprising:
a saddle leg extending from a first saddle leg end at the motor support plate to a second saddle leg end opposite the first saddle leg end, the second saddle leg end comprising the pitch adjustment flange, a first rounded surface that extends to a north side of the pitch adjustment flange, and a second rounded surface that extends to a south side of the pitch adjustment flange.

11. The motor mount assembly of claim 10,
wherein the saddle leg comprises a first saddle leg, the pitch adjustment flange comprises a first pitch adjustment flange, and the pitch adjustment slot comprises a first pitch adjustment slot, and
further comprising:
a second pitch adjustment slot at the motor mount base, and
a second saddle leg extending from a second saddle leg first end at the motor support plate to a second saddle leg second end opposite the second saddle leg first end, the second saddle leg second end comprising a second pitch adjustment flange, a third rounded surface that extends to a north side of the second pitch adjustment flange, and a fourth rounded surface that extends to a south side of the second pitch adjustment flange, the second pitch adjustment flange received at the second pitch adjustment slot, and wherein the second pitch adjustment flange is movable: (i) with the first pitch adjustment flange and (ii) relative to the second pitch adjustment slot to cause the change in pitch orientation of the motor support plate relative to the motor mount base.

12. A pitch adjustable motor truss comprising:
a motor configured to receive and rotatably drive a torque tube;
a pitch adjustable solar tracker motor mount assembly on which the motor is fixedly attached, the pitch adjustable solar tracker motor mount assembly comprising:
a motor mount base comprising a pitch adjustment slot, a first connecting portion, a second connecting portion, and a third connecting portion, the motor mount base comprising a rounded cross-sectional profile that extends about at least a portion of a perimeter of the motor mount base, and
a motor mount saddle comprising a motor support plate and a pitch adjustment flange that extends out from the motor support plate,
wherein the pitch adjustment flange is received at the pitch adjustment slot, and wherein the pitch adjustment flange is movable relative to the pitch adjustment slot to cause a change in pitch orientation of the motor support plate relative to the motor mount base;
a first truss leg connected to the first connecting portion;
a second truss leg connected to the second connecting portion; and
a third truss leg connected to the third connecting portion.

13. The motor truss of claim 12, further comprising:
a U-bolt that movably connects the motor mount saddle to the motor mount base.

14. The motor truss of claim 13, wherein, as the pitch adjustment flange moves relative to the pitch adjustment slot to cause the change in pitch orientation of the motor support plate relative to the motor mount base, the U-bolt moves about at least the rounded cross-sectional profile of the motor mount base.

15. The motor truss of claim 14, wherein a threaded end of the U-bolt extends through the motor support plate, and wherein the motor is fixedly attached to the motor support plate at least via the threaded end of the U-bolt.

16. The motor truss of claim 15, wherein each of the first connecting portion, the second connecting potion, and the third connecting portion extend out from the rounded cross-sectional profile of the motor mount base.

17. The motor truss of claim 16, wherein the motor mount base further comprises a first damper mount flange and a second damper mount flange, each of the first damper mount flange and the second damper mount flange extending out from the rounded cross-sectional profile of the motor mount base between the first connecting portion and the second connecting portion.

18. A method for installing a motor at a pitch adjustable solar tracker motor mount assembly, the method comprising the steps of:
movably attaching a motor mount saddle at a motor mount base of the pitch adjustable solar tracker motor mount assembly, the motor mount saddle comprising a motor support plate and a pitch adjustment flange that extends out from the motor support plate, the motor mount base comprising a pitch adjustment slot, and wherein the pitch adjustment flange is movably received at the pitch adjustment slot to movably attach the motor mount saddle at the motor mount base;
attaching a motor to the motor support plate;
changing a pitch orientation of the motor by moving the motor support plate in a north-south plane relative to the motor mount base at least by moving the pitch adjustment flange relative to the pitch adjustment slot in the north-south plane; and
after changing the pitch orientation of the motor, attaching a torque tube at the motor.

19. The method of claim 18,
wherein the motor mount base comprises a rounded cross-sectional profile that extends about at least a portion of a perimeter of the motor mount base,
wherein the motor mount saddle is movably attached to the motor mount base by a U-bolt that bounds at least a portion of the rounded cross-sectional profile of the motor mount base, and
wherein changing the pitch orientation of the motor by moving the motor support plate comprises moving the U-bolt in the north-south plane about the rounded cross-sectional profile of the motor mount base.

20. The method of claim 18,
wherein the torque tube is attached to the motor after each of: (i) the torque tube has been attached to a bearing housing assembly truss that is spaced apart from the pitch adjustable solar tracker motor mount assembly, and (ii) the pitch orientation of the motor is changed.
